(19) United States
(12) Patent Application Publication
(10) Pub. No.: US 2013/0335945 A1
(43) Pub. Date: Dec. 19, 2013

(54) SURFACE ILLUMINATION DEVICE

(71) Applicants: Mitsuru Okuda, Shiga (JP); Masayuki Shinohara, Kyoto (JP); Yoshimasa Osumi, Kyoto (JP); Kazuyuki Okada, Shiga (JP)

(72) Inventors: Mitsuru Okuda, Shiga (JP); Masayuki Shinohara, Kyoto (JP); Yoshimasa Osumi, Kyoto (JP); Kazuyuki Okada, Shiga (JP)

(73) Assignee: OMRON CORPORATION, Kyoto-shi, Kyoto (JP)

(21) Appl. No.: 14/002,418

(22) PCT Filed: Mar. 7, 2012
(86) PCT No.: PCT/JP2012/055843

§ 371 Date: Aug. 30, 2013

(30) Foreign Application Priority Data
Mar. 15, 2011 (JP) 2011-057301

(51) Int. Cl. F21V 8/00; F21V 33/00

(52) U.S. Cl. CPC G02B 6/0035; F21V 33/0052
USPC 362/23.06; 362/615

(57) ABSTRACT

A surface illumination device has a light source, a light guide plate that has a light-emitting surface and an opposite surface opposite to the light-emitting, wherein the light guide plate emits light introduced from the light source from a display region of the light-emitting surface, and a plurality of deflection patterns that are formed in the display region in at least one of the light-emitting surface and the opposite surface. The display region has a certain drawing pattern expressed by a set of the deflection patterns. Some of the plurality of deflection patterns are arrayed along an edge of the certain drawing pattern so as to rim the certain drawing pattern.

### BACKGROUND

1. Technical Field

The present invention relates to a surface illumination device, particularly to a display surface illumination device.

2. Related Art

In the smartphone, the tablet computer, an electronic book reader, and the like, an icon is lighted in a position of a switch, and the position and a type of the switch is expressed by the icon.

Patent Document 1: Japanese Unexamined Patent Publication No. 2001-243822

### SUMMARY

One or more embodiments of the present invention provides a surface illumination device that can smoothly or clearly express the edge of the display unit expressed by the desired drawing pattern, a graphic, a character, or the like.

In accordance with one or more embodiments of the present invention, a surface illumination device includes: a light source; a light guide plate that emits light, which is introduced from the light source, from a display region of a light-emitting surface; and plural deflection patterns that are formed in the display region in at least one of the light-emitting surface of the light guide plate and an opposite surface to the light-emitting surface, wherein the display region is one in which a certain drawing pattern is expressed by a set of the deflection patterns, and the plural deflection patterns are arrayed along an edge of the drawing pattern so as to rim the drawing pattern. As used herein, the drawing pattern includes the graphic, the pattern, and the character, but the drawing pattern is not limited to one in which a meaning can be recognized.

In the surface illumination device according to one or more embodiments of the present invention, the plural deflection patterns are arrayed along the edge of the drawing pattern so as to rim the drawing pattern. Therefore, the display unit including the set of deflection patterns can clearly be expressed, and the edge of the display unit can be smoothened.

In the surface illumination device according to one or more embodiments of the present invention, the deflection patterns that rim the drawing pattern are arrayed at constant intervals along the edge of the drawing pattern. Accordingly, the edge of the display unit can become luminous with homogeneous luminance.

In a surface illumination device according to one or more embodiments of the present invention, the deflection pattern is inscribed in a place that becomes a corner at the edge of the drawing pattern. Accordingly, the corner of the drawing pattern is not rounded, but the sharp display unit can be produced.

In a surface illumination device according to one or more embodiments of the present invention, the deflection pattern is inscribed in a place that becomes an inflection point at the edge of the drawing pattern. At this point, it is assumed that the inflection point includes a connection point of the straight line and the curve. Accordingly, the drawing pattern expressed by the display unit can easily be understood.

In a surface illumination device according to one or more embodiments of the present invention at least the three deflection patterns including the deflection patterns located at both ends are inscribed in the edge of the drawing pattern in a curve portion located between two inflection points at the edge of the drawing pattern. Accordingly, the curve can easily be expressed at the edge of the display unit.

In accordance with one or more embodiments of the present invention, a mobile phone that has transmission and reception functions, includes the surface illumination device in order to optically display a certain drawing pattern. In one or more embodiments of the present invention, the surface illumination device according to one or more embodiments of the present invention is used in mobile phones such as the smartphone. Accordingly, the display such as the icon can be clarified.

In accordance with one or more embodiments of the present invention, an information terminal that has an information processing function includes the surface illumination device in order to optically display a certain drawing pattern. In one or more embodiments of the present invention, the surface illumination device according to one or more embodiments of the present invention is used in information terminals such as a mobile computer, the tablet computer, an electronic diary, and an electronic dictionary. Accordingly, the display such as the icon can be clarified.

The scope of the present invention includes variations made by the combination of components.

### BRIEF DESCRIPTION OF THE DRAWINGS

FIG. 1(A) is a plan view of a smartphone. FIG. 1(B) is a plan view of a surface illumination device incorporated in the smartphone in FIG. 1(A).

FIG. 2(A) is a schematic sectional view of a conventional surface illumination device together with one enlarged deflection pattern. FIG. 2(B) is a plan view of a display unit (deflection pattern region) provided in a conventional light guide plate.

FIG. 3 is a view illustrating a specific design of the display unit.

FIG. 4 is an underlying pattern layout drawing that determines a deflection pattern array becoming a certain drawing pattern.

FIG. 5(A) illustrates a handset-shaped display unit that is cut out from the pattern layout drawing in FIG. 4. FIG. 5(B) is a partially enlarged view of a Q portion in FIG. 5(A).

FIGS. 6(A) and 6(B) are a plan view and a sectional view illustrating a surface illumination device according to one or more embodiments of the present invention.

FIGS. 7(A) and 7(B) are a plan view and a sectional view of a deflection pattern.

FIG. 8 is a view illustrating the deflection patterns arrayed at constant intervals along an edge of the display unit.

FIG. 9 is a schematic diagram illustrating the deflection patterns disposed in the display unit having a corner.

FIG. 10 is a schematic diagram illustrating the deflection patterns disposed in the display unit having a curve and an inflection point.

FIG. 11(A) is a partially enlarged view of the Q portion in FIG. 5(A). FIG. 11(B) is a view illustrating a deflection pattern layout in which a deflection pattern layout in FIG. 11(B) is corrected.

### DETAILED DESCRIPTION

### DESCRIPTION OF SYMBOLS

11 smartphone
12 liquid crystal display screen
13 icon
16 light guide plate
17 light source
18 deflection pattern
19 display unit
31 surface illumination device
T inflection point

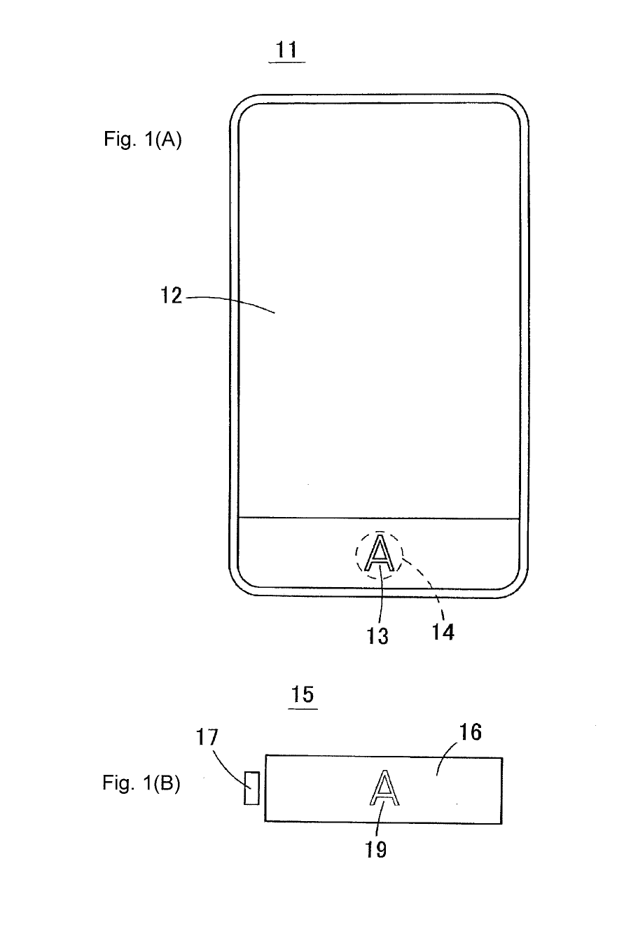

Hereinafter, embodiments of the present invention will be described in detail with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1(A) shows a smartphone 11 having an icon 13 displayed below a liquid crystal display screen 12. When the icon 13 is pressed by a finger, a switch 14 provided beneath the icon 13 is turned on to switch a function of the smartphone 11.

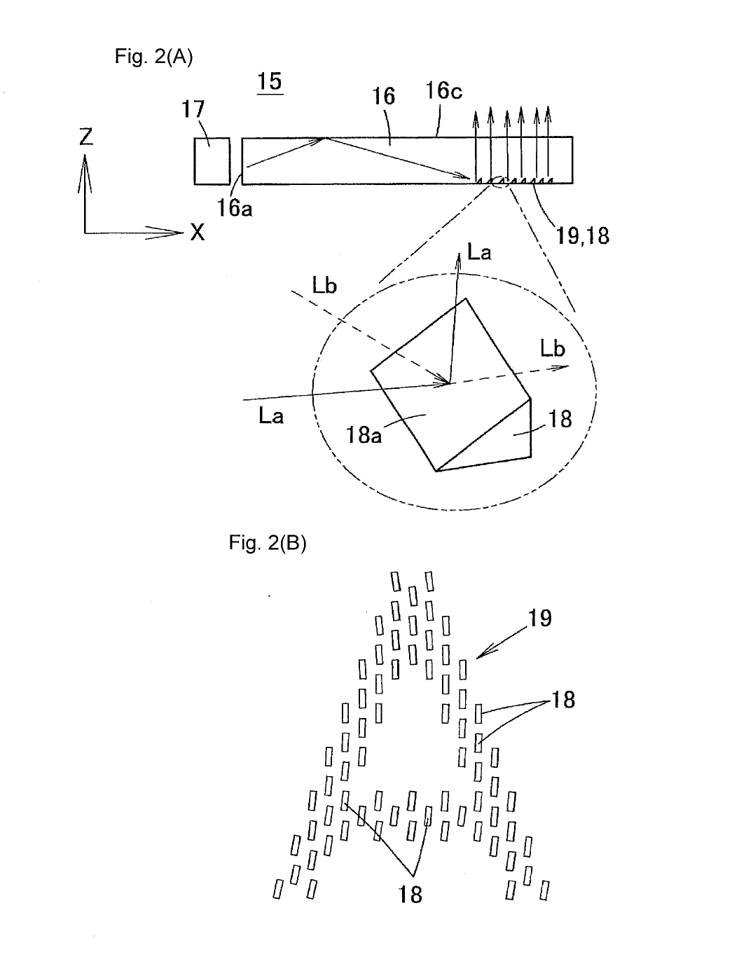

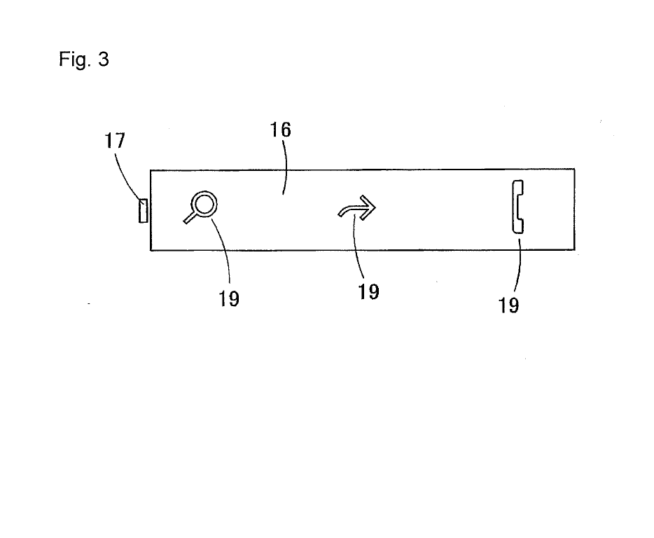

FIG. 1(B) illustrates a surface illumination device 15 for the display, which is incorporated in a lower portion of the smartphone 11 in FIG. 1(A). FIG. 2(A) illustrates a schematic section of the surface illumination device 15. The surface illumination device 15 includes a light guide plate 16 and a light source 17. The light guide plate 16 is molded using a transparent material, such as a polycarbonate (PC) resin and a polymethylmethacrylate (PMMA) resin, which has a high refractive index. The light source 17 is a minute light source (a point light source) in which an LED is used, and the light source 17 is disposed while a light exit window is opposed to one (light incident end face 16a) of end faces of the light guide plate 16. Many minute prism deflection patterns 18 are formed in a lower surface (sometimes an upper surface) of the light guide plate 16, and an icon-shaped display unit 19 is constructed by a set of deflection patterns 18 as illustrated in FIG. 2(B). The deflection patterns 18 are arrayed in an arc shape about a point near the light source 17, and extend in directions along the arc about the point. A thin, flexible light guide sheet is used as the light guide plate 16 in the case that the switch 14 is disposed beneath the display unit 19. Although the icon 13 and the display unit 19 are expressed by a character “A” in FIGS. 1(A) and 1(B), actually design marks such as a magnifying glass and a handset are frequently used as illustrated in FIG. 3.

When the light source 17 emits light in the surface illumination device 15, the light incident to the light guide plate 16 from the light incident end face 16a is guided in the light guide plate 16 while totally reflected by the upper surface, the lower surface, and both side surfaces of the light guide plate 16. When the light guided in the light guide plate 16 reaches the display unit 19 as illustrated in FIG. 2(A), the light is totally reflected by a deflection reflecting surface 18a of the deflection pattern 18. In the light totally reflected upward by the deflection reflecting surface 18a, the light incident to the upper surface (a light-emitting surface 16c) of the light guide plate 16 at an angle smaller than a total reflection critical angle is transmitted through the light incident end face 16a to emit upward (the light is transmitted while refracted by the deflection pattern 18 in the case that the deflection pattern 18 is provided in the light-emitting surface 16c). As a result, the icon-shaped light is emitted, and the icon 13 of the smartphone 11 is seen shiny.

A display unit 19 on which the icon is displayed is constructed by a set of minute deflection patterns 18. Additionally, there is a restriction to a position where the deflection pattern 18 is disposed in order to homogeneously shine the display unit 19. Therefore, even if the design mark to be used as the icon exists, it is difficult that the design mark having the smooth edge is expressed by the deflection patterns 18 as illustrated in FIG. 2(B). Particularly, for the small icon, it is necessary that the design mark be expressed with a small number of deflection patterns 18. Therefore, the smooth design mark is hardly expressed.

Even in the simple design mark, because the deflection patterns 18 are arrayed into the arc shape about the point near the light source 17, for example, it is difficult to smoothly express even the edge on the straight line.

When the deflection patterns 18 are positioned according to the design mark after the design mark is fixed, it is necessary to homogeneously shine the whole display unit, and it is necessary that a layout of the deflection patterns 18 be designed in each case such that the edge is smoothened. Even if a computer aids, it is difficult to homogeneously shine the whole display unit, and it is difficult that the layout of the deflection patterns 18 is designed in each case such that the edge is smoothened. Therefore a delivery time is lengthened, or cost increases.

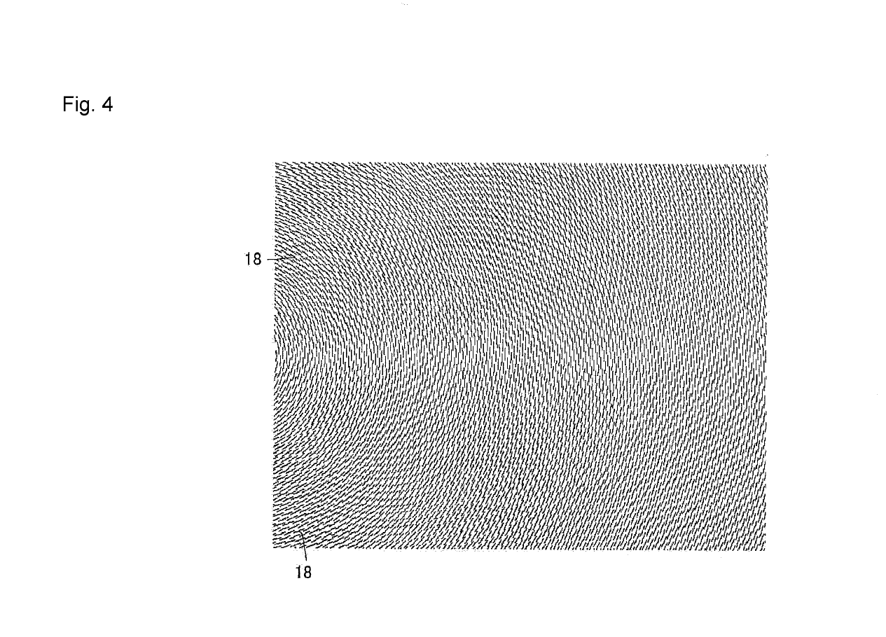

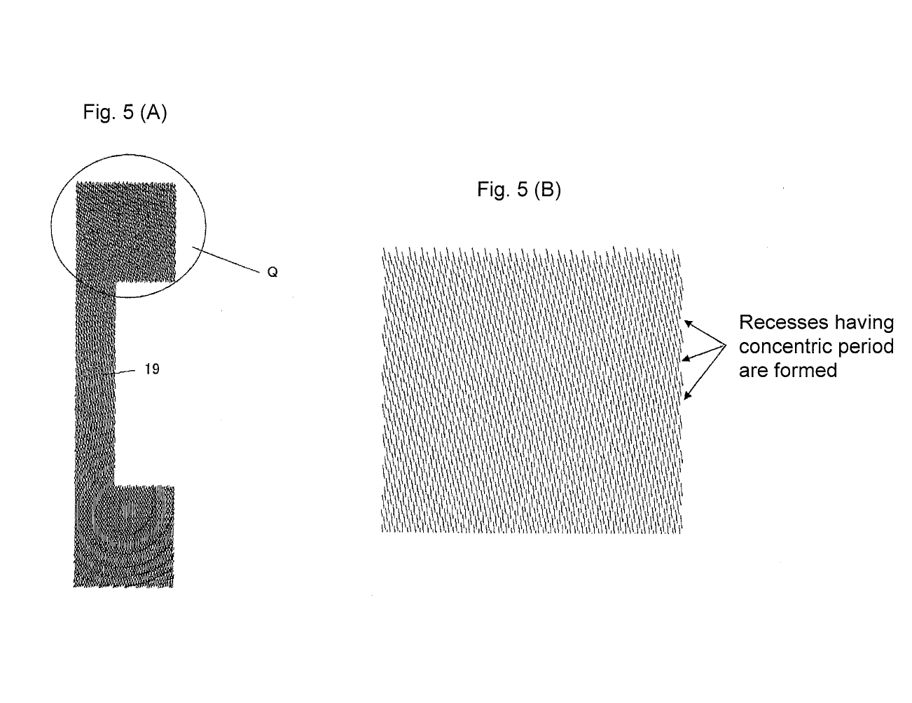

For this reason, actually a large-area deflection pattern layout that can homogeneously be shined is used as illustrated in FIG. 4. This is used in a backlight surface illumination device. The layout of the deflection patterns 18 that becomes the desired design mark are fixed as if the desired design mark is cut out from the pattern layout in FIG. 4. FIG. 5(A) illustrates a handset design mark that is taken out from the pattern layout in FIG. 4. Although the pattern layout drawing has the area identical to that of the light guide plate, FIG. 4 illustrates only part of the pattern layout drawing. Accordingly, in FIG. 4, a distribution of the deflection patterns 18 is coarser than that in FIG. 5(A). The light source 17 is located on the left side of the pattern layout in FIG. 4.

FIG. 5(A) illustrates the handset design mark that is cut out from the pattern layout in FIG. 4, and FIG. 5(B) is an enlarged view illustrating a Q portion in FIG. 5(A). In the layout of the deflection patterns 18 in FIG. 5, an edge of the design mark is not smoothened when the design mark is looked closely at. As can be seen from FIG. 5(B), the deflection pattern 18 is lacked on the edge at the right side, and a place where the edge is recessed is periodically seen. At the upper edge, the deflection patterns 18 project like a spike to form a zigzag shape. The design mark is constructed only by the straight lines in FIG. 5(A). However, the zigzag edge becomes more apparent for a drawing pattern including a diagonal line or a smooth curve.

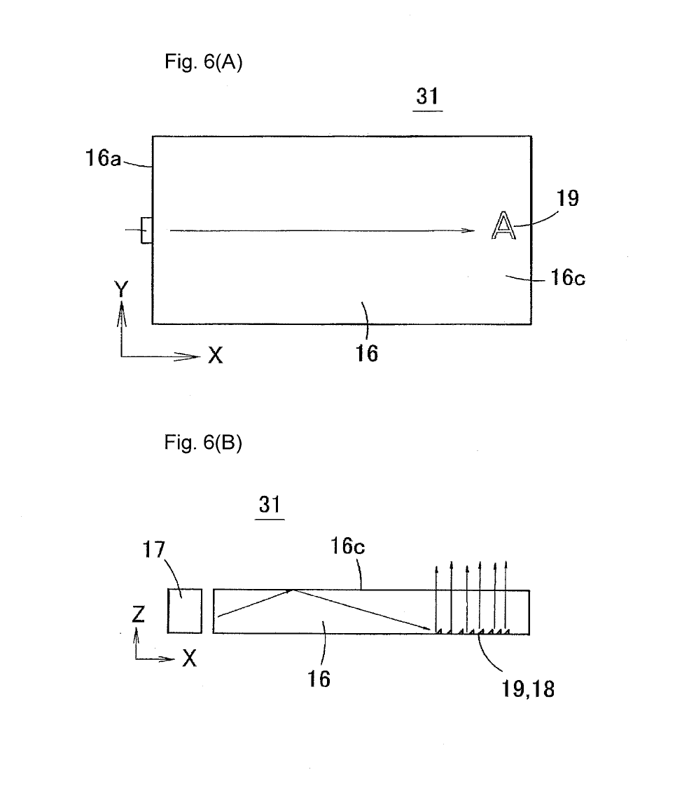

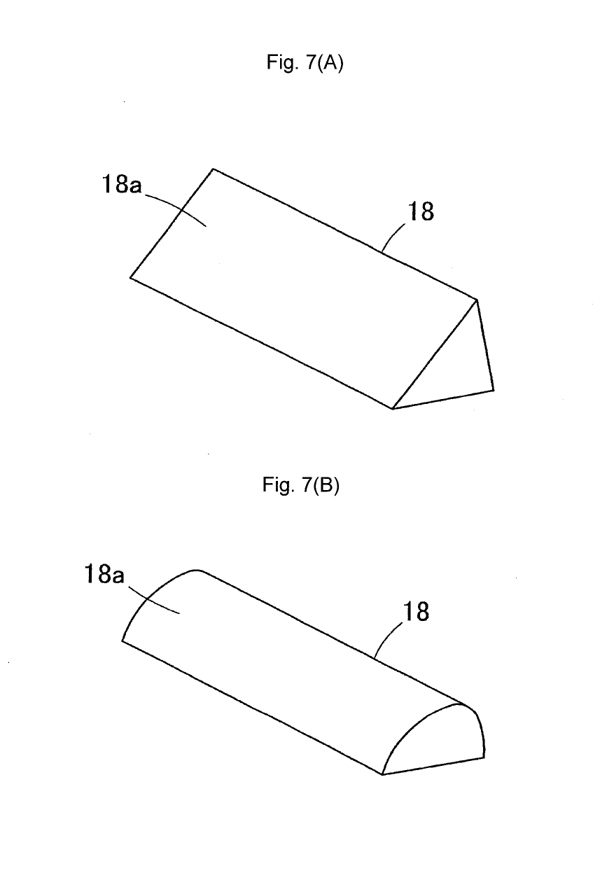

FIG. 6(A) is a plan view of a surface illumination device 31 according to one or more embodiments of the present invention. FIG. 6(B) is a sectional view of the surface illumination device 31. Because the surface illumination device 31 has a structure similar to that of the surface illumination device 15 in FIGS. 1(B) and 2(A), the component identical to that of the surface illumination device 15 is designated by the identical symbol, and the description is omitted. The deflection pattern 18 constituting the display unit 19 is generally formed into a triangular prism shape, particularly a right triangular shape as illustrated in FIG. 7(A). Alternatively, the deflection pattern 18 may be formed into a shape in which a deflection reflecting surface 18a is curved as illustrated in FIG. 7(B).

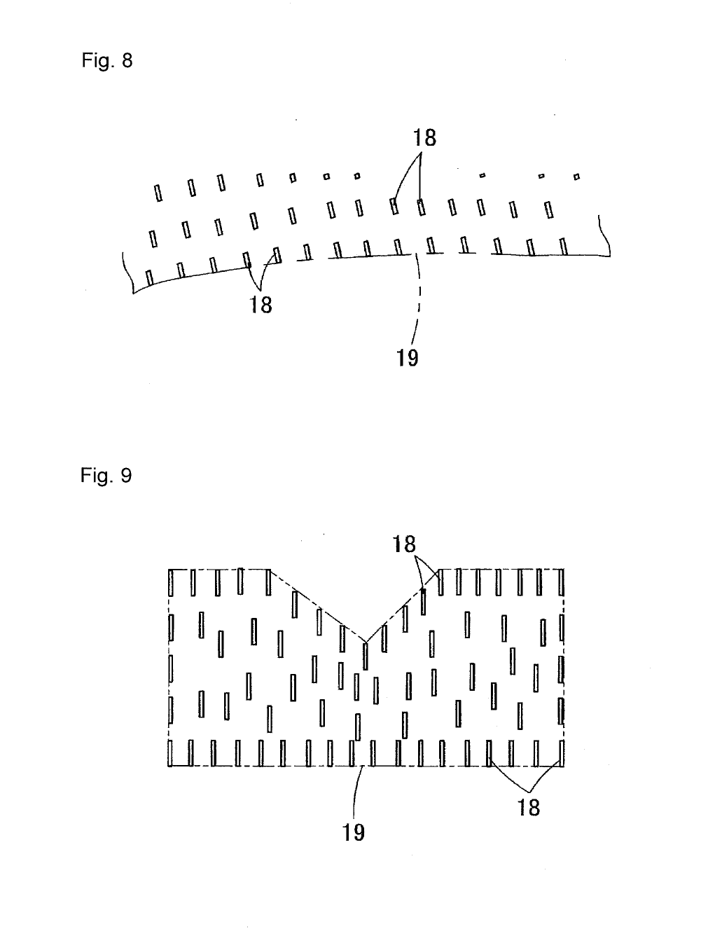

The display unit 19 of the surface illumination device 31 is constructed as illustrated in FIG. 8. An alternate long and short two dashes line in FIG. 8 indicates an edge of a drawing pattern displayed on the display unit 19. The deflection patterns 18 are arrayed at constant intervals along the edge of the display unit 19.

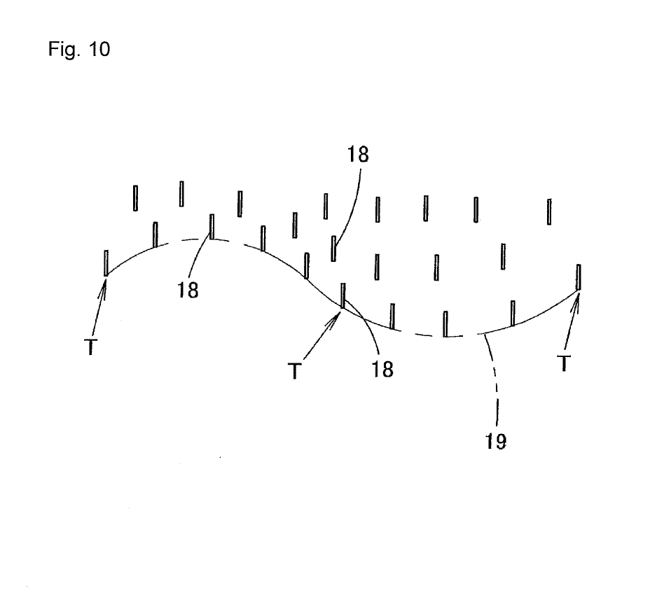

In the case that the drawing pattern has a corner, an end of the deflection pattern 18 is located at each corner as illustrated in FIG. 9. Therefore, the drawing pattern having the corner is prevented from being seen rounded.

In the case that the edge of the drawing pattern is a curve, as illustrated in FIG. 10, the deflection pattern 18 is necessarily disposed at an inflection point T where a curved direction of the curve is inverted. In one curve, for example, a substantially arc-like curve between the inflection points, at least three, and according to one or more embodiments of the present invention, at least five deflection patterns 18 including the deflection patterns 18 located the inflection points T at both ends are disposed at the edge of the drawing pattern. Therefore, the curve is prevented from looking like a polygonal line.

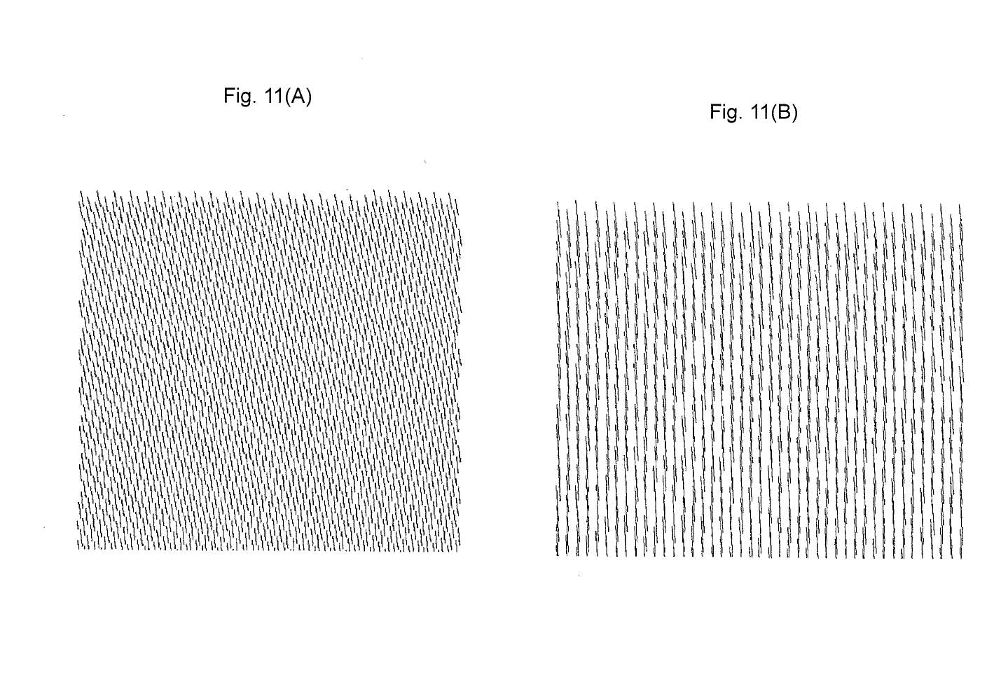

FIG. 11(A) is an enlarged view illustrating the Q portion in FIG. 5(A) (identical to FIG. 5(B)). In (a part of) the display unit 19, recesses are generated at the right and left edges to lack in sharpness. In FIG. 11(B), the deflection patterns 18 are rearranged so as to be linearly arrayed along the right and left edges of the display unit 19.

Although not illustrated, the deflection patterns 18 are not rearranged, but the deflection patterns 18 may linearly be arrayed by adding the deflection pattern 18 to each place where the edge is retreated in the display unit 19 in FIG. 11(A). The positions of the deflection patterns 18 inside the display unit 19 also change in FIG. 11(B). On the other hand, the positions of the inside deflection patterns 18 do not change in the method for adding the deflection pattern 18.

In the display unit 19 in FIG. 11(B), the upper edge is formed into a zigzag shape. Alternatively, the upper edge may be formed flat like the lower edge.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A surface illumination device comprising:
a light source;
a light guide plate that comprises a light-emitting surface and an opposite surface opposite to the light-emitting, wherein the light guide plate that emits light, which is introduced from the light source from a display region of the light-emitting surface; and
a plurality of deflection patterns that are formed in the display region in at least one of the light-emitting surface of the light guide plate and an and the opposite surface to the light-emitting surface,
wherein the display region is one in which comprises a certain drawing pattern expressed by a set of the deflection patterns, and
wherein some of the plurality of deflection patterns are arrayed along an edge of the certain drawing pattern so as to rim the certain drawing pattern.

2. The surface illumination device according to claim 1, wherein the deflection patterns that rim the certain drawing pattern are arrayed at constant intervals along the edge of the certain drawing pattern.

3. The surface illumination device according to claim 1, wherein the deflection pattern is inscribed in a place that becomes a corner at the edge of the certain drawing pattern.

4. The surface illumination device according to claim 1, wherein the deflection pattern is inscribed in a place that becomes an inflection point at the edge of the certain drawing pattern.

5. The surface illumination device according to claim 4, wherein at least the three deflection patterns including the deflection patterns located at both ends are inscribed in the edge of the certain drawing pattern in a curve portion located between two inflection points at the edge of the certain drawing pattern.

6. A mobile phone that has transmission and reception functions, comprising:
the surface illumination device according to claim 1 in order to that optically displays the certain drawing pattern.

7. An information terminal that has an information processing function, comprising:
the surface illumination device according to claim 1 in order to that optically displays the certain drawing pattern.
